(19) United States
(12) Patent Application Publication
(10) Pub. No.: US 2011/0222060 A1
(43) Pub. Date: Sep. 15, 2011

(54) MONOCHROMATOR COMPRISING VARIABLE WAVELENGTH SELECTOR IN COMBINATION WITH TUNABLE INTERFERENCE FILTER

(76) Inventors: Stanley Desmond Smith, Edinburgh (GB); Roger William Peter Fenske, Edinburgh (GB); Dirk Ulrich Nather, Livingston (GB)

(21) Appl. No.: 13/123,931

(22) PCT Filed: Oct. 14, 2009
(86) PCT No.: PCT/GB2009/002448

§ 371 Date: May 18, 2011

(30) Foreign Application Priority Data
Oct. 14, 2008 (GB) 0818822.9

(51) Int. Cl. G02B 5/28; G01J 3/28

(52) U.S. Cl. 356/326; 359/578

(57) ABSTRACT

A system for spectrally filtering light is provided. The system includes a variable wavelength selector for selecting a wavelength from a light source and a tunable interference filter for filtering light from the variable wavelength selector. The interference filter may be synchronously tunable to the output of the variable wavelength selector.

The present invention relates to the field of optical spectrometry generally and, in particular fluorescence spectroscopy. To achieve higher luminosity and suppress stray light and unwanted grating orders automatically, the present invention uses tunable interference filters.

### BACKGROUND OF THE INVENTION

Monochromators are often used in optical spectroscopy. A monochromator generally comprises an entrance slit for admitting an incident beam of light having a range of wavelengths, a diffraction grating and an exit slit through which light is transmitted at a substantially monochromatic wavelength. The bandwidth of the light output is determined by the width of the exit slit. The wavelength of the monochromator can be tuned across a desired range by rotating the diffraction grating. A photodetector is used to record the optical power as a function of the wavelength.

Within a monochromator, particularly from the grating, a proportion of light is scattered and appears as a stray signal at the photodetector, see the article by T. N. Woods, R. T, Wrigley, G. J. Rottman & R. E. Haring App. Optics 33, 4273-4285. This stray signal can lead to unacceptable performance when measuring weak fluorescence spectra. To reduce this problem, the monochromator output can be improved using a second monochromator having a wavelength that is tuned to be substantially equal to the wavelength of the first monochromator, thereby reducing stray light. However, such an arrangement requires twice the number of optical components, has a reduced optical throughput and a larger footprint. Furthermore, at the extremes of a grating spectral range throughput drops off significantly. Gratings inevitably reflect second and higher diffraction orders through the exit slit giving unwanted stray shortwave signals.

### SUMMARY OF THE INVENTION

According to a first aspect of the invention, there is provided a system for spectrally filtering light using a variable interference filter synchronously tuned to a wavelength selected by a device that has a variable wavelength output, for example a grating or a fabry perot filter. The interference filter can have a very high background wide band rejection to five or six orders of magnitude of rejection.

By using a variable wavelength selector, such as a single monochromator, in conjunction with such a tunable interference filter, there is provided an optical system that has the substantially same spectral performance as the known double monochromator, but a significantly improved background rejection and sensitivity. For many applications, such as fluorescence spectroscopy of biological samples in particular, this is very important. This superior performance can be provided in a cheaper, more compact spectrometer.

The system may include a controller for controlling the synchronously tuning of the variable interference filter and the wavelength selector. The controller may, for example, store calibration data for synchronous tuning which may, for example, take the form of a look-up table comprising output wavelength values and the corresponding filter settings that are required to substantially align the wavelength of the tunable interference filter with grating setting output. Interpolation may subsequently be used to control a filter setting corresponding to a desired monochromator wavelength, which is intermediate in value between two of the stored monochromator wavelength values.

The calibration data for synchronous tuning may, alternatively, take the form of an equation/expression and associated fitting parameters for a desired monochromator wavelength to calculate filter setting that is required to substantially align the wavelength of the tunable interference filter with the monochromator wavelength.

The tunable interference filter may comprise variable thickness interference layers along the lateral direction. This is known as a wedge filter. By masking part of the wedge the transmitted wavelength can then be caused to vary.

The tunable interference filter may utilise a transparent substrate such as glass, quartz or the like.

Additionally, the tunable interference filter may comprise a pair of reflective elements. The reflective elements may have reflective surfaces that are parallel. An intermediate air gap layer may be provided between the surfaces of the reflective elements. The interference filter may be tunable by changing the dimension of this air gap.

The tunable interference filter may have a pass band of wavelengths the width of which can be designable or can be a long wavelength pass (LWP) edge filter or a shortwave pass (SWP) as determined by the design of the multilayers, e.g. J. S. Seeley and S. D. Smith Applied Optics, 5, 81-85, 1966.

The tunable interference filter may comprise a filter actuator that is operable to tune the wavelength by translating the filter perpendicularly to the optical axis and to the line of the spectrometer slits.

The filter actuator may be automatically actuated. The filter actuator may, for example, comprise a worm and wheel and a stepper motor or an adaption of printer mechanics.

The monochromator variable wavelength selector may comprise a reflective diffraction grating.

The tunable interference filter may be positioned at various locations in the optical train, for example either side of entrance and exit slits. Positioning the filter at the exit slit, and in particular on the same side of the exit slit as the diffraction grating and contiguous with the light detector, is particularly advantageous because it results in the largest improvement in the suppression of stray light and, correspondingly the largest improvement in signal to noise ratio. This is important in fluorescence spectroscopy applications where the fluorescence may be weak.

The use of the synchronous filter significantly improves the signal to noise ratio of the industrial standard “Water Raman” Test of fluorescence spectrometer sensitivity.

The system may be an absorption or other form of spectrometer. The spectrometer may include a sample area; an excitation source for illuminating the sample area and an emission path that includes the variable wavelength selector and the tunable interference filter.

The source may comprise a narrow band light source such as a narrow band laser source and, in particular, a tunable laser source. The light source may be a broadband light source such as a white light source, supercontinuum laser, or a flash lamp i.e. a continuous wave source such as a Xenon lamp or the like combined with a fixed or tunable bandpass filter to determine excitation wavelengths.

The system may comprise two wedge interference filters moved synchronously for wavelength control and with respect to each other for band width control. This device would allow the spectral selection and triggering of a supercontinuum source. The device would prevent beam distortion in comparison with the use of a grating for wavelength selection. In addition the triggering mechanism would minimize temporal beam walk.

According to another aspect of the invention, there is provided a method of spectrally filtering light comprising selecting an output wavelength using a variable wavelength selector, and synchronously tuning a variable interference filter to the selected output wavelength, thereby to provide a spectrally filtered output. The method may involve scanning the output wavelength and the tunable filter across a wavelength range.

The method may involve using a wedge interference filter and using of off-axis illumination of a spherical mirror to provide a line focus to define the area of the filter wedge illuminated, and so the wavelength of the output.

### BRIEF DESCRIPTION OF THE DRAWINGS

The present invention will now be described further by way of example only with reference to the accompanying drawings, of which:

FIG. 1 is a fluorescence spectrometer;

FIG. 2 is a detailed schematic view of a wedge-type variable interference filter for use in the spectrometer of FIG. 1;

FIG. 3 is a schematic transmission spectrum of the wedge-type variable interference filter of FIG. 2;

FIG. 4 compares transmission spectra for a wedge-type variable interference filter and an emission monochromator arrangement measured during calibration of the spectrometer of FIG. 1;

FIG. 5 shows a calibration curve for the wedge-type variable interference filter of FIG. 2 when used in the spectrometer of FIG. 1;

FIG. 6 illustrates the experimental set-up used for stray light rejection measurements using the wedge-type variable interference filter and emission monochromator arrangement of the spectrometer of FIG. 1;

FIG. 7 compares the transmission spectrum of the emission monochromator arrangement with the wedge-type variable interference filter removed to the transmission spectrum of the emission monochromator arrangement with the wedge-type variable interference filter in place as measured using the experimental set-up of FIG. 6;

FIG. 8 shows the transmission spectra of FIG. 7 on a semi-log scale;

FIG. 9 compares the transmission spectrum of the emission monochromator arrangement with the wedge-type variable interference filter removed to the transmission spectrum of a double monochromator as measured using the experimental set-up of FIG. 6;

FIG. 10 shows the transmission spectra of FIG. 9 on a semi-log scale;

FIG. 11 shows the transmission of stray light through the second element of the double monochromator and interference filter after a single monochromator normalised to take account of transmission at the selected transmission wavelength;

FIG. 12 is a detailed schematic view of the spectrometer of FIG. 1 in the vicinity of an alternative variable interference filter;

FIG. 13 shows various alternative positions for a variable interference filter within the spectrometer of FIG. 1;

FIG. 14 is a schematic diagram of an interference monochromator;

FIG. 15 shows two plots of transmission versus wavelength for the monochromator of FIG. 14, and

FIG. 16 is a schematic diagram of a tunable light source that uses a supercontinuum laser.

### DETAILED DESCRIPTION OF THE DRAWINGS

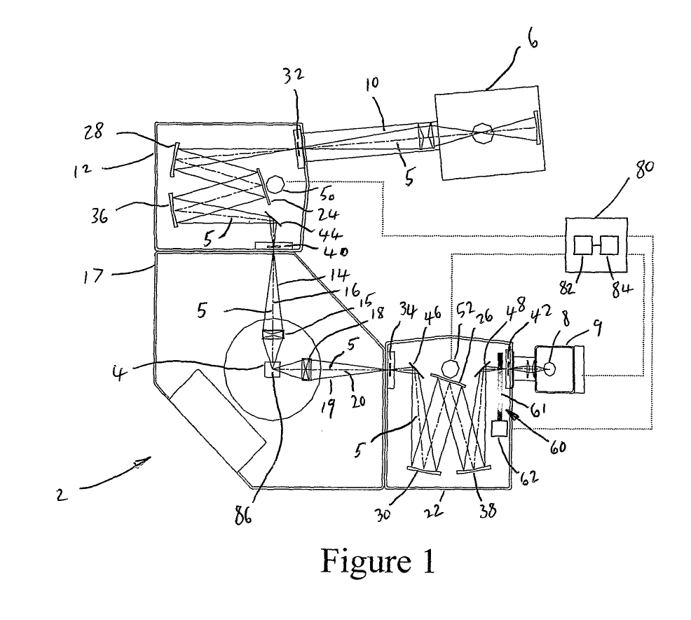

FIG. 1 shows a fluorescence spectrometer 2 for measuring fluorescence from a sample 4. The spectrometer 2 has a light source 6, such as a Xenon lamp, having an output power of for example 5 to 450 W, and a photodetector 8, for example a red sensitive (185-900 nm) Hamamatsu Photonics R928P photomultiplier tube (PMT) in a Peltier cooled housing 9. On the optical axis 5 of the spectrometer 2 is an excitation monochromator 12 for spectrally filtering light to produce an excitation beam 14, which is then focussed by an excitation lens 15 onto the sample 4 along an excitation portion 16 of the optical axis 5. The sample 4 and the excitation lens 15 are both housed in a sample chamber 17.

Fluorescence emitted from the sample 4 is collected by an emission lens 18 that couples an emission beam 19 along an emission portion 20 of the optical axis 5 into an emission monochromator 22. The emission portion 20 of the optical axis 5 is substantially perpendicular to the excitation portion 16 to limit the amount of excitation light on the emission path. In general, the fluorescence (and therefore the emission beam 19) has a wavelength that is different from a wavelength of the excitation beam 14. The emission monochromator 22 spectrally filters the emission beam 19 and the filtered fluorescence is coupled onto the PMT 8.

Each excitation and emission monochromator 12,22 has a reflective diffraction grating 24,26, for example a grating that has 1800 grooves/mm. Each grating 24,26 is rotatable via stepper motors 50,52 respectively so as to vary the wavelength of the light transmitted by the monochromators 12,22. To collimate and direct light, a collimating element is provided in the form of a concave mirror 28,30 between the entrance slit 32,34 and the diffraction grating 24,26. A focussing element, in the form of a further concave mirror 36,38, is also provided for focussing light towards the exit slit 40,42, which slit 40,42 determines the transmission bandwidth. To direct light from the concave mirror 36 towards the exit slit 40, the excitation monochromator 12 has an output steering mirror 44. Similarly, to direct light from the entrance slit 34 towards the concave mirror 30, the emission monochromator 22 has an input steering mirror 46 and for directing light from the further concave mirror 38 to the exit slit 42 an output steering mirror 48.

Within the emission monochromator 22 at a position adjacent the exit slit 42 between the output steering mirror 48 and the exit slit 4 is a tunable interference filter 60 that has a wedge-type variable interference filter 61 and a linear actuator 62 comprising a stepper motor. The tunable interference filter 61 provides additional spectral filtering and is tuned to light from the monochromator grating. Off-axis illumination of a spherical mirror (not shown) may be used provide a line focus to define the area of the filter wedge illuminated, and so the wavelength of the output.

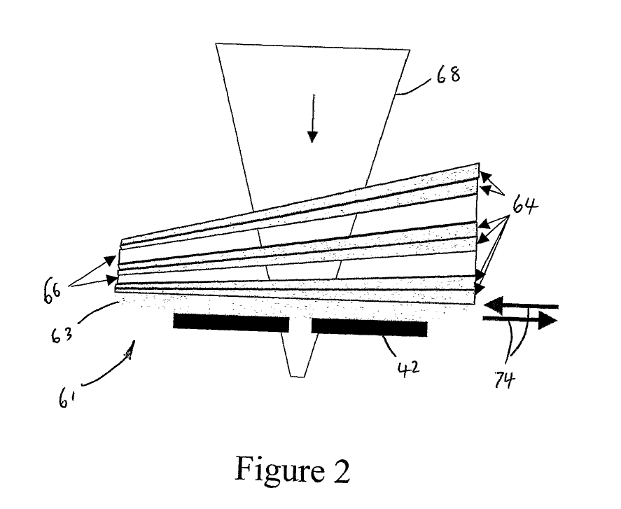

FIG. 2 shows the wedge type filter 61 in more detail. This has a substrate 63 having reflective layers 64 and cavity layers 66 deposited thereon. Two cavity layers 66 are sandwiched between reflective layers 64. The thicknesses of the reflective and cavity layers 64,66 vary across the width of the wedge-type variable interference filter 61 (i.e. moving from left to right in FIG. 2). At a given position across the width, the reflective and cavity layers 64 and 66 are designed to be quarter-wavelength and half-wavelength layers respectively for a given design wavelength. This type of filter is well known, and described for example in the article “Design of Multilayer Filters by Considering Two Effective Interfaces” by S. D. Smith—J. Optical Soc. Of America, 48, 43-50, 1958, the contents of which are incorporated herein by reference.

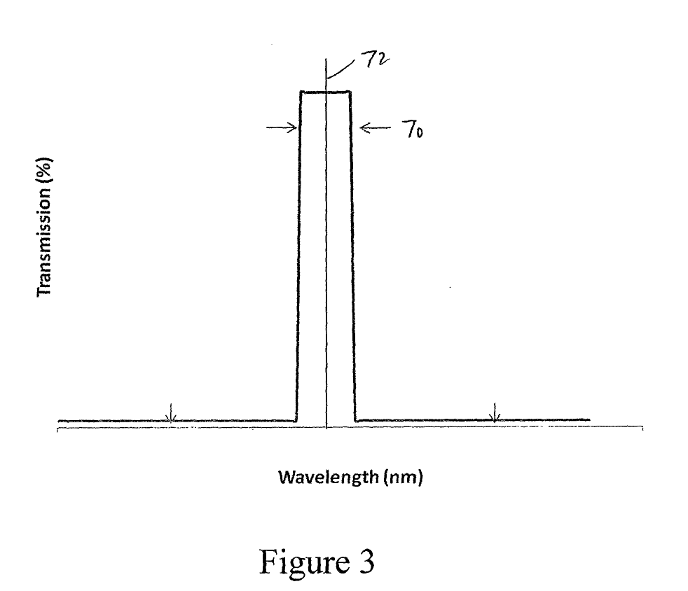

FIG. 3 shows the transmission spectrum for a beam of light 68 incident on the wedge-type variable interference filter 61. This has a passband shape that has a width, in this case 25 nm, determined in part by the rate of change of thickness of the layers 64,66 and the extent of the beam 68 across the width of the filter 61. The passband is centred round the design wavelength 72. This may be tuned by translating the filter 61 relative to the beam of light 68 in the direction of the width of the wedge-type variable interference filter 61 as indicated by the arrows 74 in FIG. 2. This can be done over a spectral range of, for example, approximately 300-700 nm or more.

Included in the spectrometer 2 is a controller 80 having a processor 82 and a memory 84. As indicated by the dotted lines in FIG. 1, the controller is arranged for communication with the PMT 8, the grating stepper motors 50,52 and the stepper motor of the filter linear actuator 62. In use, the electrical PMT signal is transmitted from the PMT 8 to the controller 80 where the data may be processed by the processor 82 or stored in the memory 84.

Prior to using the spectrometer 2, the wedge-type variable interference filter 61 is removed and the emission monochromator grating 26 is calibrated in terms of absolute wavelength according to conventional methods. This is required because raw spectra, acquired by scanning the monochromator through a wavelength range and monitoring the signal on the detector, will not be a true representation of the sample being measured. The sensitivity of the detector, throughput of the monochromator and performance of the optics will all vary with wavelength and so will give a contribution to the measured spectra. The acquired spectra have to be corrected in order to obtain a true spectrum of the emission from the sample. Correction is applied by dividing the measured spectrum by a correction file.

To attain a correction file a calibrated light source (such a tungsten lamp), where the spectrum is precisely known, is placed above the sample chamber so that the light is incident on a piece of PTFE scatter located at the sample position 86. The spectrum of the lamp is measured using the emission arm of the spectrometer; this is divided by the known spectrum of the lamp to give a spectrum of the sensitivity of the instrument—the calibration file, which can then be used to correct measurements. The same correction regime can be used with a system containing a single monochromator and variable interference filter.

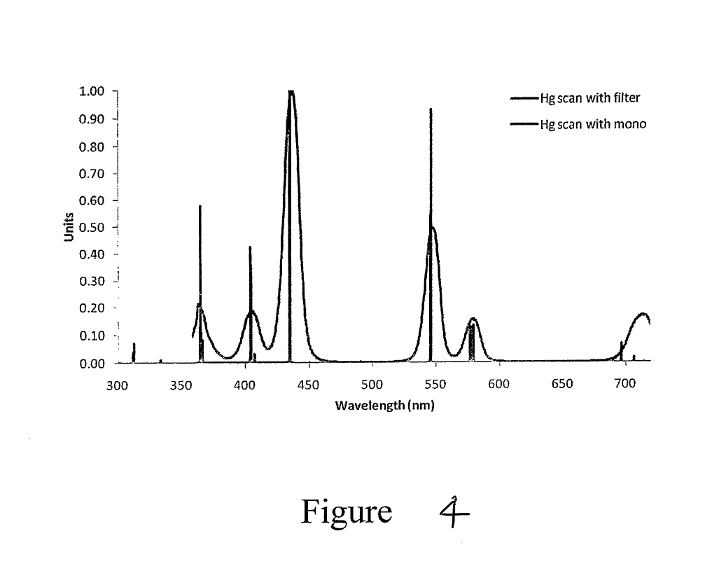

To synchronise the wavelength 72 of the interference filter 61 with the wavelength of the light transmitted by the emission monochromator exit slit 42 (hereinafter the emission monochromator wavelength), the sample 4 is removed from the spectrometer 2 and the light source 6 is switched off. A mercury lamp (not shown) is coupled into an optical fibre (not shown) and the distal end of the optical fibre is located at the sample position 86, so that the emission lens 18 collects light from the lamp. With the wedge-type variable interference filter 61 initially removed from the spectrometer 2, the PMT signal is measured for each emission monochromator wavelength, for example over the range of 200-870 nm, and stored in the controller memory 84 along with the corresponding emission monochromator wavelength value. The corresponding plot of PMT signal as a function of emission monochromator wavelength is shown in FIG. 4, and appears as a series of spikes corresponding to the emission lines of the mercury lamp.

The wedge-type variable interference filter 61 is subsequently calibrated against the emission monochromator grating 26 as follows. The filter 61 is replaced in the system and the emission monochromator grating 26 is set to a zero order position using the stepper motor 52 so that it functions as a non-dispersive plane mirror. The PMT signal is then monitored as the wedge-type variable interference filter 61 is translated through the mercury lamp light by the stepper motor of the filter actuator 62. At each position of the stepper motor of the filter linear actuator 62 (hereinafter the filter stepper motor), the PMT signal value and the corresponding position of the filter stepper motor are stored in the controller memory 84. The resulting plot of PMT signal as a function of the filter stepper motor position comprises a series of broad peaks with each peak corresponding to one of the mercury lamp lines, as shown in FIG. 4.

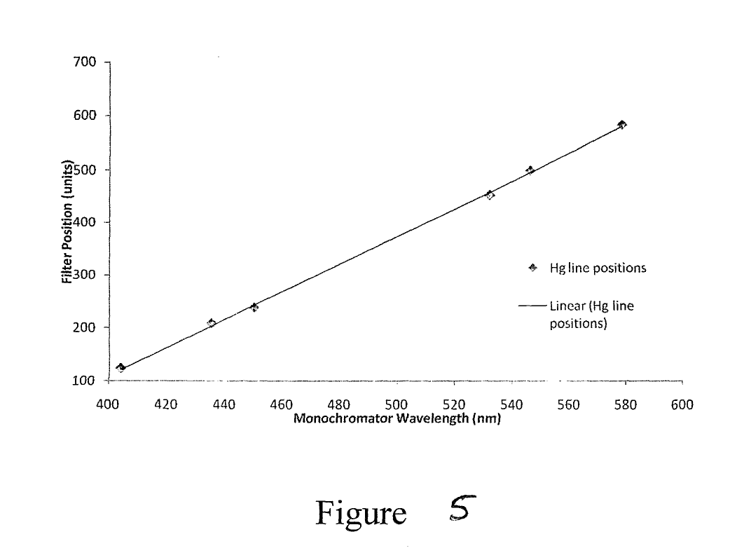

Using the data of FIG. 4 and the stored filter stepper motor positions, a plot of filter position against emission monochromator wavelength can be derived, as shown in FIG. 5. These data points can be stored in the controller memory 84, so that the filter can be readily tuned to the monochromator wavelength. In some cases, the plot is close to or can be approximated by a linear fit, as illustrated in FIG. 5. In other cases, however, the relationship may be non-linear, in which case a polynomial fitting function, typically a fourth-order function, is used as a compromise between calibration accuracy and the instability problems that can occur with higher-order polynomials.

An alternative method, using a broadband source, such as a Xenon lamp, can be used to calibrate the variable interference filter on its own, if the monochromator has already been calibrated. The monochromator is moved to a set of wavelengths. At each of these wavelengths the filter is moved over its range and the spectrum recorded. A peak-searching algorithm can be used to find the maximum value of the spectrum i.e. the motor position where the filter and monochromator wavelengths are the same. The set of filter positions and wavelengths can then be used to generate a polynomial fitting function. This method does not require a calibrated light source and so can be used if a filter is exchanged for one with a different wavelength range, or dimensions. In addition, once the selected wavelengths have been chosen, the calibration process can be automated in software.

Synchronous tuning of the monochromator and the interference filter may be achieved by software. In this case, in response to an instruction to move to a particular wavelength, the controller passes an instruction to the monochromator actuator to move to a position corresponding to a monochromator wavelength and at the same time passes an instruction to the filter actuator to move to a position corresponding to the a wavelength equal to the monochromator wavelength. Synchronous tuning may alternatively be achieved by hardware linking wherein the monochromator actuator is mechanically linked to the filter actuator, so that movement on the monochromator actuator automatically causes movement of the filter to a position at which it is tuned to the same wavelength as the monochromator. As another alternative, synchronous tuning may be achieved by firmware linking wherein a single instruction to move to a wavelength is passed to firmware that passes respective instructions to the monochromator and filter actuators to move to respective positions corresponding to the wavelength.

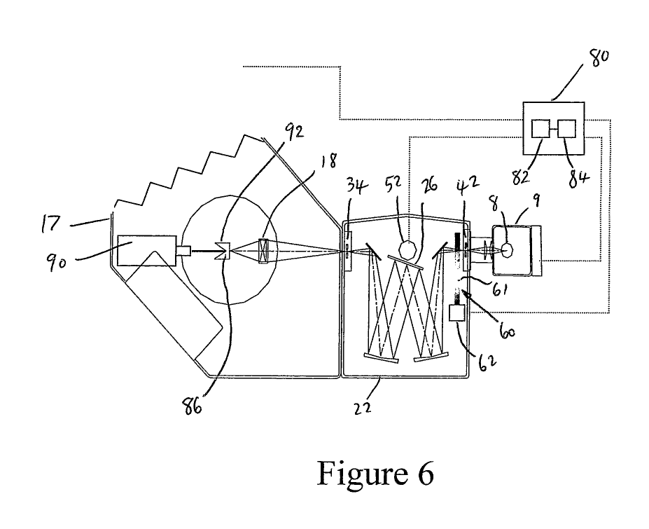

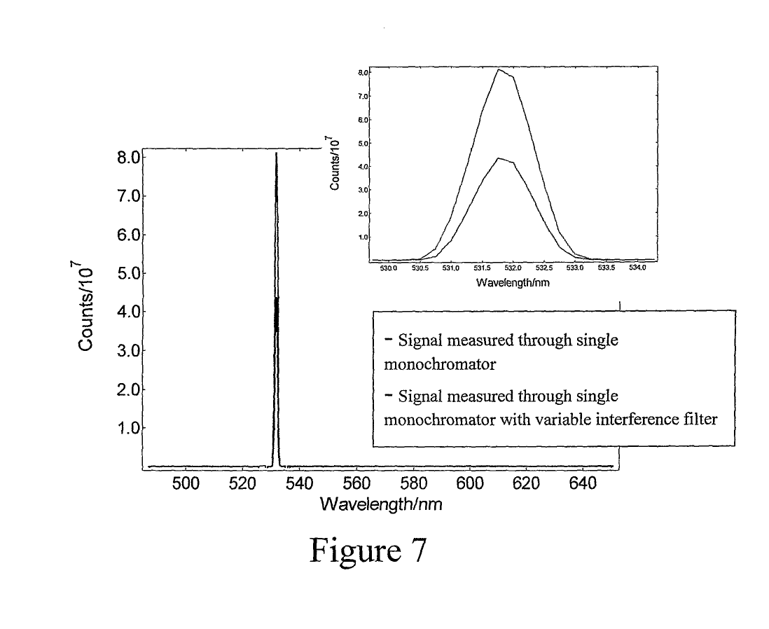

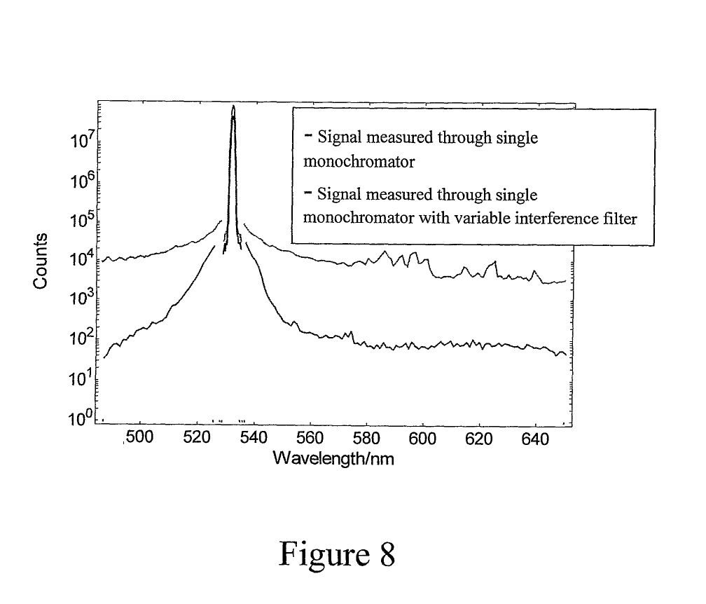

FIG. 6 shows an experimental set-up used to assess the stray light performance of the emission monochromator 22 with and without the synchronously tuned wedge-type variable interference filter 61 in place. With the sample 4 removed from the sample chamber 17, a Nd:YAG laser 90 having a frequency doubled output at 532 nm was placed in the sample chamber 17. Light from the Nd:YAG laser 90 was directed towards a PTFE scatter source 92 located at the sample position 86 to simulate diffuse luminescence from a sample and the emission lens 18 was used to collect and couple the simulated diffuse luminescence at 532 nm into the entrance slit 34 of the emission monochromator 22. The plots of PMT signal as a function of wavelength with and without the filter 61 in place are plotted in FIGS. 7 and 8.

From FIG. 7, it is apparent that there is a reduction in optical throughput of the emission arm with the filter 61 in place. From FIG. 8, it is also apparent that the PMT noise floor associated with stray light for the emission monochromator 22 with the filter 61 in place is at least two orders of magnitude lower than that without the filter 61 in place at least across the wavelength range of the emission monochromator 22 shown in FIG. 8.

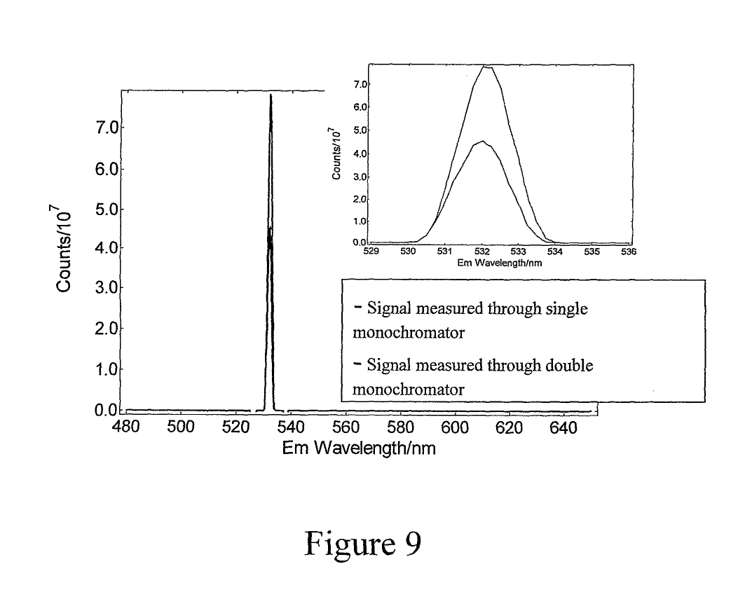

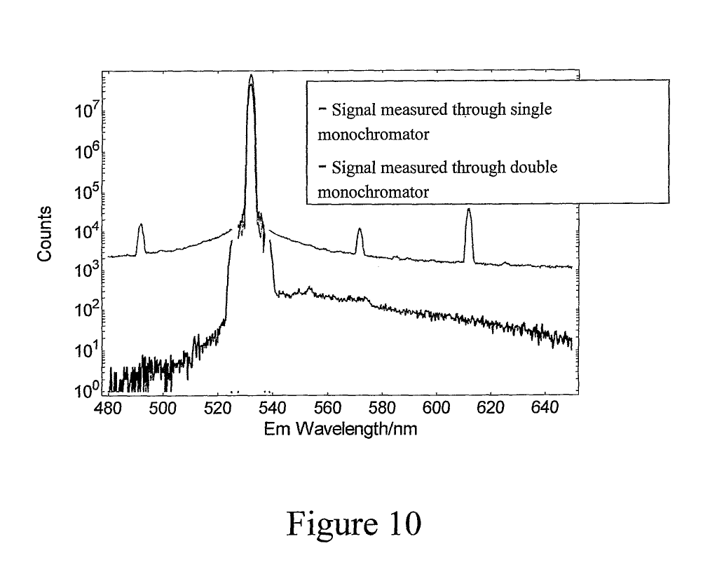

The experimental set-up of FIG. 6 was also used to assess the stray light performance of a double monochromator and compare this with the performance of the first monochromator of the double monochromator. The corresponding plots of PMT signal as a function of wavelength for the emission monochromator 22 without the filter 61 in place and for the double monochromator are plotted in FIGS. 9 and 10.

From FIG. 9 it is apparent that there is a reduction in optical throughput when the double monochromator is used rather than just the first monochromator of the double monochromator. The optical throughput performance of the double monochromator is, therefore, of a similar order to that observed for the emission monochromator 22 with the synchronously-tuned wedge-type variable interference filter 61 in place at 532 nm, which is close to the optimal (blaze) wavelength of the gratings used. The optical throughput of the second monochromator of the double monochromator will reduce at wavelengths further from this blaze wavelength, as indeed it will for all diffraction grating monochromators. However, the interference filter will not be affected in this way, as it does not have the constraint of a blaze wavelength.

From FIG. 10, it is also apparent that the PMT noise floor associated with stray light for the double monochromator is only between one to two orders of magnitude lower than the PMT noise floor associated with stray light of the emission monochromator 22 without the interference filter 61 in place at some wavelengths across the wavelength range of the emission monochromator 22 shown in FIG. 10.

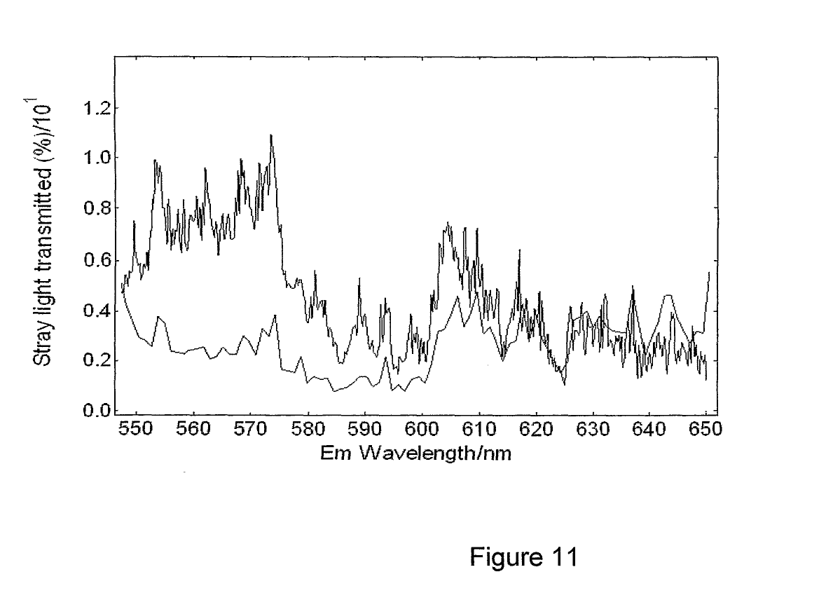

FIG. 11 shows the transmission of stray light through the second element of the double monochromator and interference filter after a single monochromator normalised to take account of transmission at the selected transmission wavelength (532 nm) i.e. it shows the transmission of stray light by the second monochromator of the double monochromator and the interference filter. It is apparent from the figure that the emission monochromator 22 with the interference filter 61 in place has superior stray light rejection compared with the double monochromator arrangement over most of the wavelength range 550-650 nm. Accordingly, the sensitivity of the emission monochromator 22 with the interference filter 61 is superior to the double monochromator arrangement.

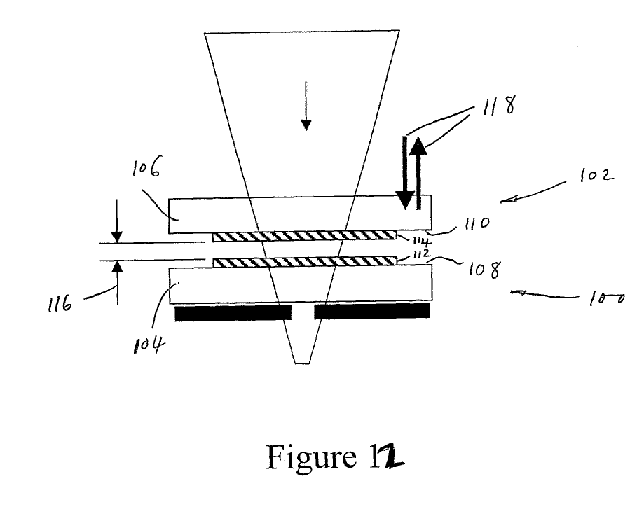

Whilst the above systems have been described with reference to a wedge type filter, any suitable variable interference filter can be used. FIG. 12 shows an example of an alternative filter. This has a pair of reflective elements 100,102, each reflective element comprising a quartz substrate 104,106 having a polished surface 108,110 on which a reflective stack of dielectric layers 112,114 is deposited. Each reflective surface 112,114 faces, is parallel to and spaced apart from the reflective surface 114,112 of the other reflective element. The reflective surfaces are separated by an air gap 116 that is adjustable by moving the reflective element 102 towards or away from the reflective element 100 as indicated by the arrows 118.

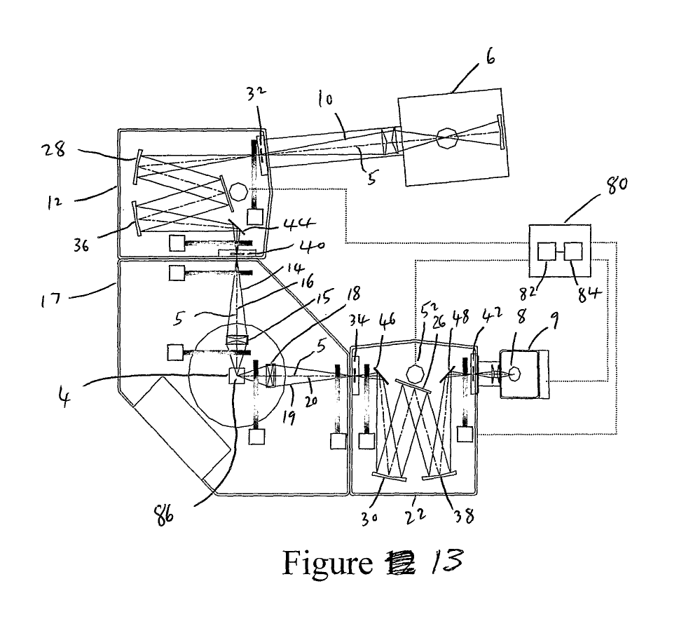

FIG. 13 illustrates several alternative positions for the tunable interference filter 60 along the optical axis of the spectrometer 2 of FIG. 1. For example, the filter 60 may be located between the entrance slit 34 and the steering mirror 46 of the emission monochromator 22. Alternatively, the interference filter 60 may be located within the excitation monochromator 12 between the steering mirror 44 and the exit slit 40 or just after the entrance slit. Further alternative positions of the interference filter 60 are located within the sample chamber 17. For example, the interference filter 60 may be located in the sample chamber 17 at a position before the excitation lens 15, between the excitation lens 15 and the sample position 86, between the sample position 86 and the emission lens 18 or after the emission lens 18.

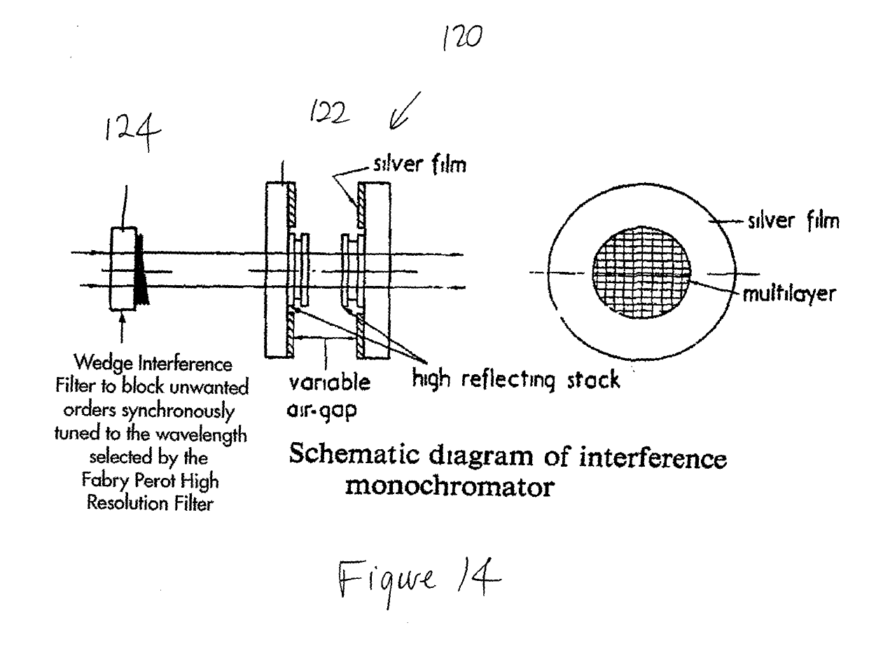

FIG. 14 shows another system in which the invention is embodied. This is an interference monochromator 120 in which a high-resolution fabry-perot filter 122 with a variable air gap is used in combination with a wedge interference filter 124. Fabry-perot filters are known in the art and so will not be described herein in detail.

Moving the fabry-perot filter 122 shifts the transmitted wavelength. In use, the fabry-perot filter 122 is moved to the position required to output the wavelength of interest and the wedge interference filter 122 is used to spectrally filter the resultant fabry-perot output. As with the previously described embodiments, the fabry-perot filter 122 and the wedge interference filter 124 are synchronously tuned. Synchronous tuning may be achieved by for example software or hardware or firmware linking wherein a single instruction to move to a wavelength is passed to firmware that passes respective instructions to the wedge filter 124 and the fabry-perot filter 122 actuators to move to respective positions corresponding to the desired wavelength.

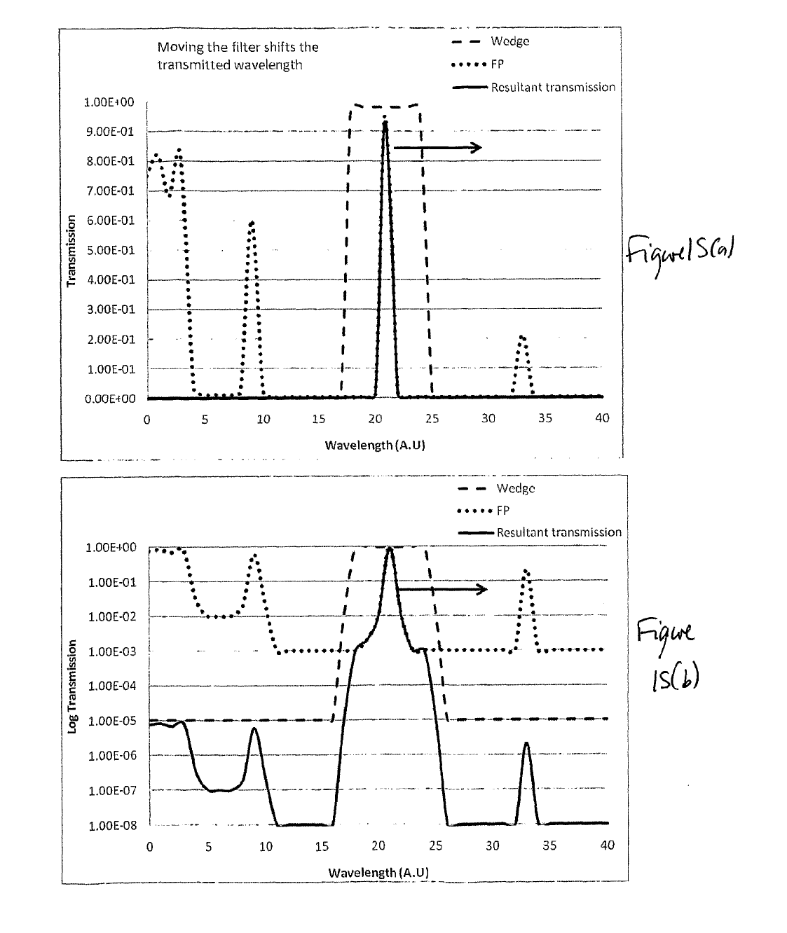

FIG. 15 shows the combined effect of the filter 122 and the wedge 124. FIG. 15(a) shows transmission versus wavelength for the monochromator of FIG. 14, and FIG. 15(b) shows the same data but on a log scale. From these, it can be seen that the tunable wedge filter 124 suppresses the higher order wavelengths output by the fabry-perot filter 122. Hence, the combination of the tunable wedge filter 124 and the variable fabry-perot filter 122 provides a high quality spectrally filtered output.

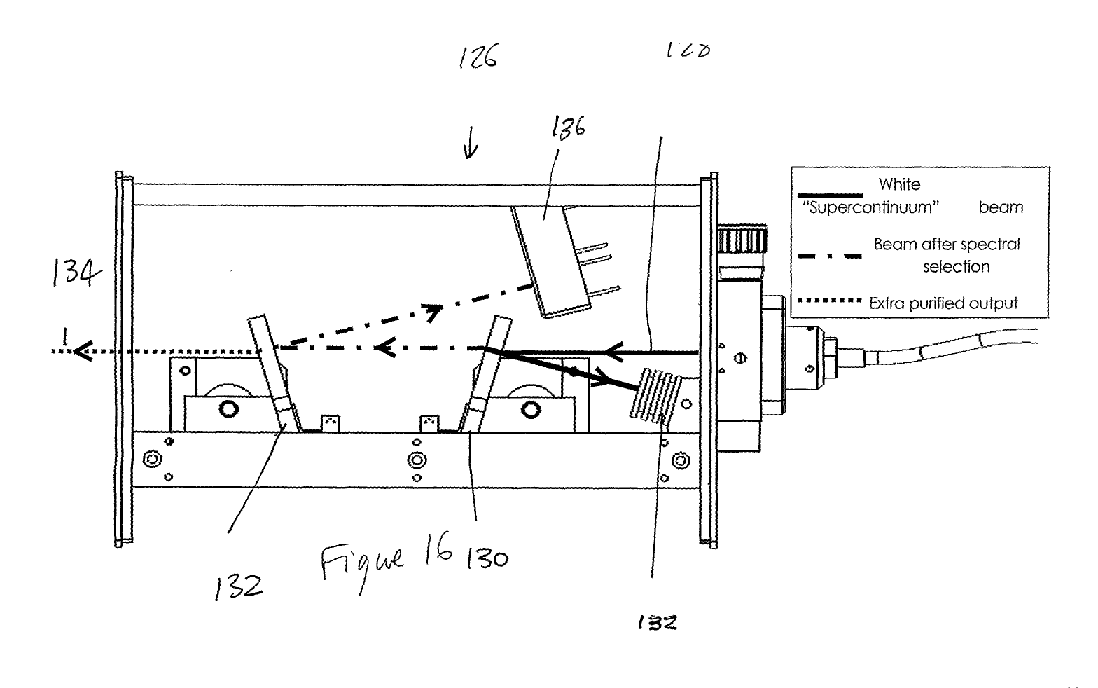

FIG. 16 shows a system 126 that allows wavelength selection for a supercontinuum laser. The output from the supercontinuum source 128 is incident on a first bandpass wedge interference filter 130. The first interference filter 130 transmits one wavelength and reflects the rest of the light into a beam dump 132. The bandpass interference filter 130 may be a single device or a pair of high and low wavelength pass filters. The transmitted wavelength depends on the lateral position of the supercontinuum beam on the filter 130. The radiation transmitted by the first filter 130 then passes through a second wedge interference filter 132 for spectral purification, i.e. extra rejection of unwanted wavelengths, to produce a high quality output beam 134. The reflection from the second wedge interference filter 134 is incident on a trigger diode 136 to allow triggering of the supercontinuum by the wavelength of interest thus minimising temporal beam walk. The filters 130,134 are tuned synchronously to change the wavelength transmitted. Alternatively, by moving the filters 130,134 with respect to each other the high wavelength pass edge of one filter and the low wavelength edge of the other will determine the spectral bandwidth, therefore the spectral bandwidth may be altered.

A skilled person will appreciate that variations of the disclosed arrangements are possible without departing from the invention. For example, although the system of FIG. 1 is described with reference to capturing emissions from a sample, for example luminescence such as electroluminescence, photoluminescence, fluorescence or the like, the light may be transmitted through or reflected by the sample. Accordingly the above description of the specific embodiment is made by way of example only and not for the purposes of limitation. It will be clear to the skilled person that minor modifications may be made without significant changes to the operation described.

1. A system for spectrally filtering light comprising a variable wavelength selector for selecting a wavelength from a light source in combination with a tunable interference filter for filtering light from the variable wavelength selector, wherein the interference filter is synchronously tunable to the output of the variable wavelength selector.

2. A system as claimed in claim 1 wherein the variable wavelength selector comprises a grating.

3. A system as claimed in claim 1 wherein the variable wavelength selector comprises a filter.

4. A system as claimed in claim 3 wherein the variable wavelength selector and/or the tunable interference filter comprise a wedge type interference filter.

5. A system as claimed in claim 4 wherein the tunable interference filter comprises a variable interference filter that varies along a lateral direction.

6. A system as claimed in claim 5 wherein the variable interference filter has at lest one or more layers that vary in thickness along the lateral direction.

7. A system as claimed in claim 1 wherein the tunable interference filter is linear or circular in design.

8. A system as claimed in claim 1 wherein the tunable interference filter has a pass band that is determined by a cone of incidence and area of the beam in the lateral direction incident on the variable interference filter and the position of incidence of the beam along the lateral direction.

9. A system as claimed in claim 1 wherein the tunable interference filter is movable with respect to an optical axis along the lateral direction.

10. A system as claimed in claim 1 wherein the tunable interference filter comprises a pair of reflective elements wherein at least one of the reflective elements is movable relative to the other to provide the wavelength tuning synchronous to the grating.

11. A system as claimed in claim 10 wherein the reflective elements have reflective surfaces that are parallel.

12. A system as claimed in claim 1 wherein one variable wavelength selector comprises a diffractive or a refractive element.

13. A system as claimed in claim 1 wherein the light comprises any form of emission from a sample, for example fluorescence.

14. A system as claimed in claim 1 comprising a supercontinuum light source.

15. A system as claimed in claim 1 wherein the system is a tunable wavelength source.

16. A system as claimed in claim 1 comprising one or more controllers for synchronously tuning the interference filter and the variable wavelength selector.

17. A spectrometer or a monochromator that includes the system of claim 1.

18. A method of spectrally filtering light comprising selecting an output wavelength using a variable wavelength selector, and synchronously tuning a variable interference filter to the selected output wavelength, thereby to provide a spectrally filtered output.

19. A method as claimed in claim 17 comprising scanning the output wavelength and the tunable filter across a wavelength range.

20. A method as claimed in claim 17 comprising using a wedge interference filter and using of off-axis illumination of a spherical mirror to provide a line focus to define the area of the filter wedge illuminated, and so the wavelength of the output.
